(19) United States
(12) Patent Application Publication
(10) Pub. No.: US 2015/0279336 A1
(43) Pub. Date: Oct. 1, 2015

(54) BIDIRECTIONAL DISPLAY METHOD AND BIDIRECTIONAL DISPLAY DEVICE

(71) Applicant: SEIKO EPSON CORPORATION, Tokyo (JP)

(72) Inventor: Shun IMAI, Matsumoto-Shi (JP)

(21) Appl. No.: 14/669,885

(22) Filed: Mar. 26, 2015

(30) Foreign Application Priority Data
Apr. 1, 2014 (JP) 2014-075194

(51) Int. Cl. G09G 5/377; G09G 5/36; G09G 5/38; G09G 5/00

(52) U.S. Cl. CPC G09G 5/377; G09G 5/003; G09G 5/363; G09G 5/38; G09G 2354/00; G09G 2340/10; G09G 2340/0464

(57) ABSTRACT

A bidirectional display method includes: receiving an image signal inputted from an external device; displaying an image on a screen on the basis of a display signal; detecting an operation on the screen; outputting the display signal for displaying the image formed by combining an external image based on the image signal and an operation input object corresponding to the operation on the screen; detecting a predetermined operation as a movement instruction; and outputting the display signal for displaying the external image moved in a direction toward a side of the screen when the movement instruction is detected.

The entire disclosure of Japanese Patent Application No. 2014-075194, filed Apr. 4, 2014 is expressly incorporated by reference herein.

### BACKGROUND

1. Technical Field

The present invention relates to a bidirectional display method and a bidirectional display device.

2. Related Art

Recently, a device provided with a touch panel display so as to accept an operation on a screen has come into use. Also, in a projection-type display device such as a projector, the function of accepting an operation on a screen using an infrared light curtain or the like is realized. See, for example, JP-A-10-319488, JP-A-2005-109978, JP-A-2013-97354, and JP-A-2007-78808.

Meanwhile, in the case of operating an area outside an external image based on an image signal inputted from an external device and thereby recording a note or the like during a conference on the outside of the external image so that a letter or chart expressed by the external image will not become less visible, if the areas outside the external image are dispersed, there is a problem that it is difficult to effectively use the available areas for recording.

### SUMMARY

An advantage of some aspects of the invention is that the areas outside the external image are brought together, thus facilitating recording of a graphic pattern, letter or the like.

(1) A bidirectional display method according to an aspect of the invention includes: receiving an image signal inputted from an external device; displaying an image on a screen on the basis of a display signal; detecting an operation on the screen; outputting the display signal for displaying the image formed by combining an external image based on the image signal and an operation input object corresponding to the operation on the screen; detecting a predetermined operation as a movement instruction; and outputting the display signal for displaying the external image moved in a direction toward a side of the screen when the movement instruction is detected.

According to the aspect of the invention, the external image can be moved toward an end from the center of the screen and therefore the areas outside the external image can be gathered together within the screen. Therefore, a note or the like can be recorded more easily in the areas outside the external image.

(2) In the bidirectional display method, in the detecting of the movement instruction, an operation to a predetermined area in the screen may be detected as the movement instruction.

By employing this configuration, the user can move the external image toward an end from the center of the screen without leaving the screen.

In the bidirectional display method, when the movement instruction is detected, (3) each external image of a plurality of the external images may be moved in a different direction from the others, or (4) each external image of a plurality of the external images may be moved by a different distance from the others, or (5) a plurality of the external images may be moved in such a way as to contact each other.

For example, it is possible to enlarge the area outside the external image at the center of the screen by moving two external images in the opposite directions to each other, or to enlarge the area outside the external image at the peripheral edge of the screen by moving an apex of one of two external images to an apex of the screen and moving the other external image in such a way that the two external images share a side.

The aspect of the invention can also be applied to a bidirectional display device. The function of each unit described in the appended claims is implemented by a hardware resource with the function thereof specified by the configuration thereof, a hardware resource with the function thereof specified by a program, or a combination of these. The functions of the respective units are not limited to those implemented by hardware resources that are physically independent of each other.

### BRIEF DESCRIPTION OF THE DRAWINGS

The invention will be described with reference to the accompanying drawings, wherein like numbers reference like elements.

FIGS. 1A and 1B show screen configurations according to an embodiment of the invention.

FIG. 2 is a block diagram according to an embodiment of the invention.

FIG. 3 is a flowchart according to an embodiment of the invention.

FIGS. 4A to 4C show screen configurations according to an embodiment of the invention.

FIGS. 5A to 5C show screen configurations according to an embodiment of the invention.

FIG. 6 is a flowchart according to an embodiment of the invention.

FIG. 7 shows a screen configuration according to an embodiment of the invention.

FIGS. 8A to 8D show screen configurations according to an embodiment of the invention.

FIGS. 9A and 9B show screen configurations according to an embodiment of the invention.

FIGS. 10A and 10B show screen configurations according to an embodiment of the invention.

### DESCRIPTION OF EXEMPLARY EMBODIMENTS

Hereinafter, an embodiment of the invention will be described with reference to the accompanying drawings. The components corresponding to each other in the respective drawings are denoted by the same reference numbers and will not be described in duplicate.

### 1. Outline

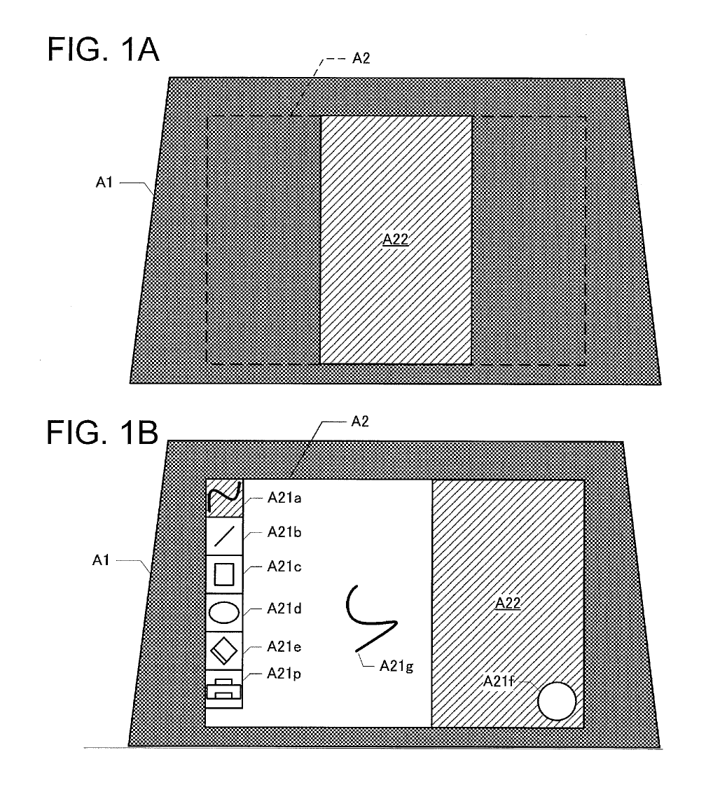

A projector 1 as an example of a bidirectional display device according to the invention is a device which projects and displays an image on a projection screen such as a wall, desk, or dedicated screen. The projector 1 operates in a first mode in which an external image based on an image signal inputted from an external device such as a PC or smartphone is projected on a screen, and in a second mode in which an operation input object corresponding to an operation on a screen and an external image are projected on the screen. In the first mode, as shown in FIG. 1A, an external image A22 is projected on a screen A2. The external image A22 is arranged in the center of the screen A2. Here, the screen refers to a valid area where the display device can project an image in a rectangular shape. For example, since the distance from the projection light source of the projector to the projection surface varies depending on the position on the projection surface, even if an image is drawn in a rectangular shape in the projector, the image formed on the projection surface is not a similar figure to that image. Therefore, the area where the entirety of an image adjusted into a rectangular shape on the projection surface or converted according to the brightness and color temperature of the projection space is drawn is the screen.

In the second mode, as shown in FIG. 1B, the external image A22 is arranged at an edge of the screen A2, and an operation input object A21g including a curve or the like is projected with the external image A22. In the second mode, as the projector 1 detects an operation on the screen, the projector 1 draws and projects the operation input object A21g such as a curve corresponding to an operation trajectory.

### 2. Configuration of Projector

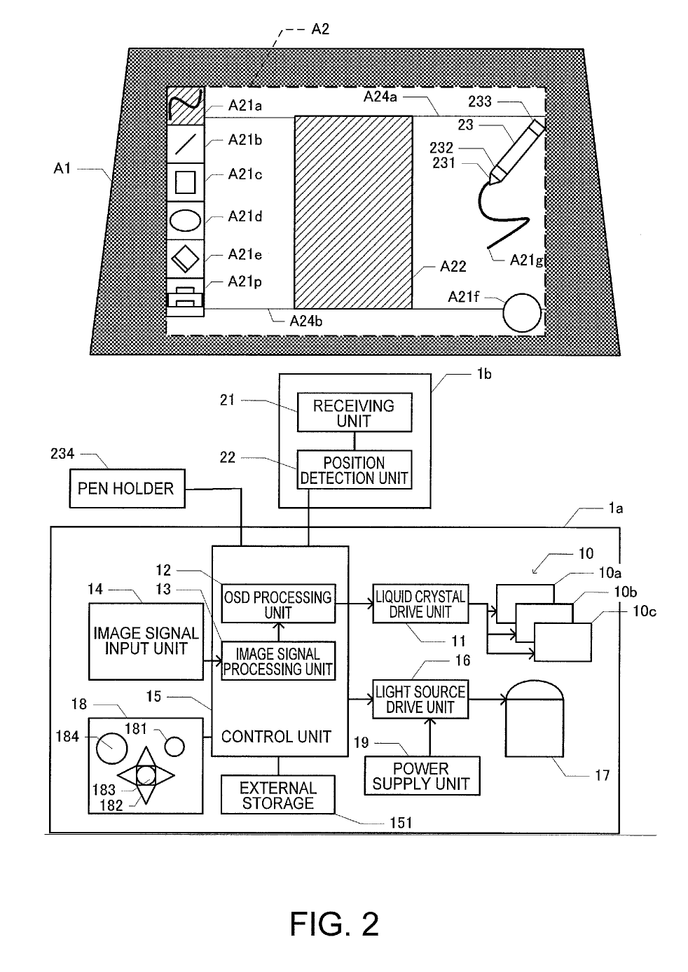

As shown in FIG. 2, the projector 1 has a light source drive unit 16, a projection light source 17, a liquid crystal light valve 10 and a liquid crystal drive unit 11, as a display unit in a first casing 1a. The projector 1 also has an image signal input unit 14, a control unit 15, an external storage 151, an operation unit 18, and a power supply unit 19 or the like. The projector 1 also has a receiving unit 21 and a position detection unit 22, as an operation detection unit, in a second casing 1b connected to the first casing 1a. Moreover, the projector 1 has an electronic pen 23 as a transmitting unit.

The projection light source 17 is made up of a high-pressure mercury lamp, LED (light emitting diode), laser or the like, and driven by the light source drive unit 16. The image signal input unit 14 has multiple types of input terminals such as USE terminal, Ethernet (trademark registered) terminal, and RS232c terminal, and has various image signals inputted thereto from an external device. The control unit 15 executes a control program stored in the external storage 151 and thereby controls each part of the projector 1. The control unit 15, also functioning as a drawing unit, has an image signal processing unit 13 and an OSD processing unit 12, executes drawing processing on the basis of an image signal inputted from an external device and an operation position signal inputted from the position detection unit 22, and outputs a projection signal as a display signal. The image signal processing unit 13 outputs image data (window image data) corresponding to an entire screen as a result of the drawing processing based on the image signal inputted from the external device and the operation position signal inputted from the position detection unit 22. The OSD processing unit 12 outputs a projection signal corresponding to the liquid crystal light valve 10 on the basis of the window image data. The liquid crystal drive unit 11 converts the projection signal outputted from the OSD processing unit 12, to an analog signal for driving each pixel of the liquid crystal light valve 10. The liquid crystal light valve 10 has three liquid crystal panels 10a, 10b, 10c, each controlling, for each pixel, the transmittance of light beams of red, green, and blue wavelengths radiated from the projection light source 17 and separated by a dichroic mirror, not shown. The operation unit 18 has a menu key 181 for inputting an instruction to project an OSD menu, a selection key 182 and a decision key 183 for selecting an OSD menu item, and a power switch 184 for turning on and off the power supply to the power supply unit 19 from an external power source. The power supply unit 19 supplies power to each part of the projector 1.

The receiving unit 21 is an infrared video camera which picks up an image of the entirety of a projection area A1. The receiving unit 21 receives infrared-wavelength light, and outputs image data corresponding to the infrared-wavelength light cast from the electronic pen 23 during the period when the tip of the electronic pen 23 is in contact with the projection surface within the projection area A1. The position detection unit 22 analyzes the image data outputted from the receiving unit 21, thereby detects the light emitting position of the infrared-wavelength light, that is, the position of the electronic pen 23, and outputs an operation position signal indicating the position of the electronic pen 23. The operation position signal is converted to coordinates in the projection area A1 or on the screen A2 by the control unit 15.

The electronic pen 23 has a contact sensor 231, a light emitting unit 232, and a power switch 233, in a pen-shaped casing. The contact sensor 231 is provided at the tip of the electronic pen 23 and detects a contact state and a non-contact state with an object. The light emitting unit 232 is provided near the tip of the electronic pen 23, and casts infrared-wavelength light as an operation signal during the period when the contact sensor 231 detects the contact state with the object. The power switch 233 is a switch for controlling the power supply to the contact sensor 231 and the light emitting unit 232 from a battery, not shown.

### 3. Bidirectional Projection Method

### 3-1. Setting of Drawing Area

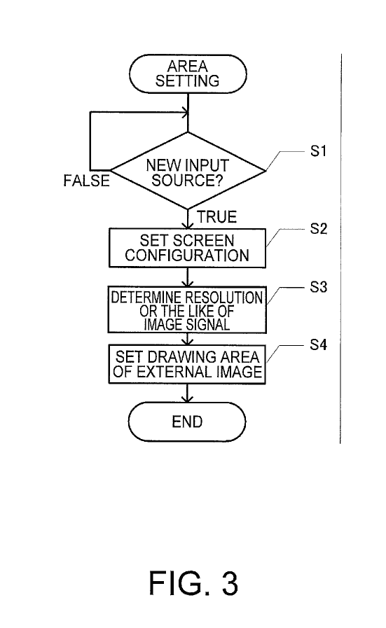

First, the setting of the screen in the projection area and of the area where an external image is drawn within the screen will be described with reference to FIG. 3.

As an image signal is inputted to the image signal input unit 14 from a new external device, the control unit 15 starts the area setting processing shown in FIG. 3 (S1). Specifically, as the image signal input unit 14 detects that the input of an image signal to an arbitrary input terminal is started, the control unit 15 starts the area setting processing of Step S2 and subsequent steps. Therefore, if the external device inputting an image signal is switched to another one, the drawing area is reset.

As an image signal is inputted to the image signal input unit 14 from a new external device, the control unit 15 sets a screen configuration that defines how an external image should be arranged within the screen (S2). In this example, either one-screen display in which one external image is arranged in the center of the screen, or two-screen equal-division display in which the screen is horizontally divided into two equal areas, with one external image arranged in each area, can be set as a screen configuration. Specifically, the control unit 15 outputs a projection signal for projecting an OSD menu including screen configuration options that can be set, and sets the screen configuration selected by the user using the operation unit 18.

Next, the control unit 15 determines the format such as the screen resolution of the image signal inputted to the image signal input unit 14 (S3).

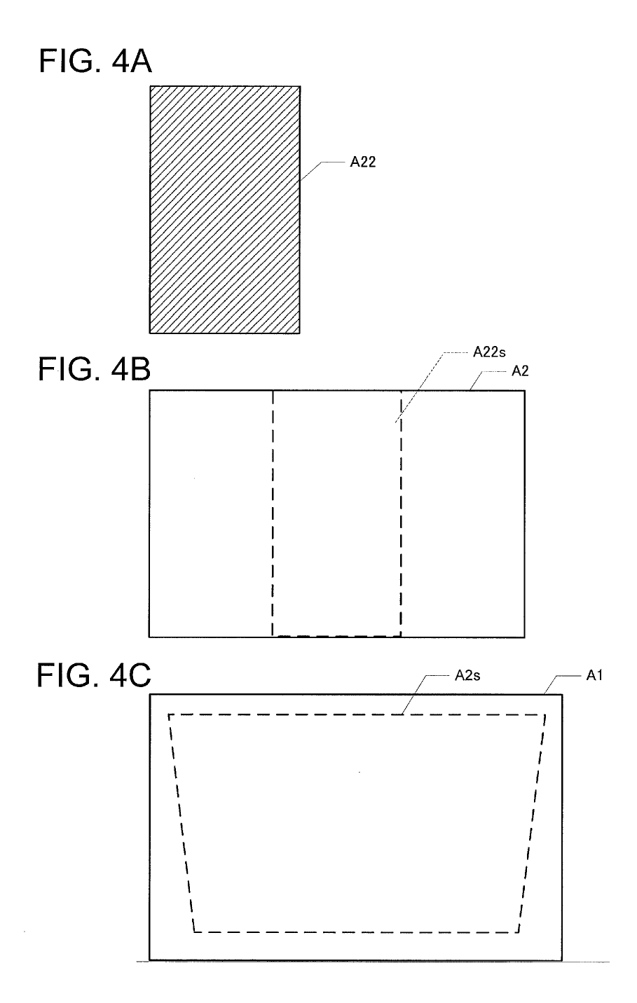

Then, the control unit 15 sets a drawing area of the external image on the basis of the screen configuration, the resolution of the image signal inputted to the image signal input unit 14, the resolution (real resolution) of the valid area of the liquid crystal light valve 10, and a keystone correction value (S4). Specifically, the area of the screen with respect to the projection area, which is the maximum area that the projector 1 can project, is decided by the basis of the resolution of the valid area of the liquid crystal light valve 10 and the keystone correction value. In the case where keystone correction is carried out, the area of the screen A2 is a non-rectangular area that is smaller than the projection area A1, which is the maximum area that the projector 1 can project, as indicated by the dashed line A2s in FIG. 4C. The keystone correction value may be automatically set on the basis of the result of detecting the projection state, or may be set by the user using the OSD menu. Also, the maximum area within the screen where one external image can be drawn is decided by the screen configuration. Moreover, the drawing area of the external image within the screen is decided according to the aspect of the maximum area and the aspect of the external image. As the area of the screen A2 with respect to the projection area A1 is set and the drawing area A22s of the external image A22 with respect to the screen A2 is set in this manner, the drawing area of an external image A11 with respect to the projection area A1 corresponding to the valid area of the liquid crystal light valve 10 is set. Details thereof will be described later.

### 3-2. Drawing Processing in First Mode

The control unit 15 enlarges or reduces the external image in such a way that the resolution matches the set drawing area, on the basis of the image signal inputted from the external device, and then draws the external image in the set drawing area.

In the first mode, the control unit 15 draws in black, both the area outside the screen in the projection area A1 and back area of the external image in the screen A2. In the first mode, the control unit 15 draws the projection area A1 in this manner and thus outputs a projection signal corresponding to the pixels forming the liquid crystal light valve 10. As a result, in the first mode, the other parts than the external image A22 in the projection area A1 are projected in black, as shown in FIG. 1A. The dashed line A2 is an imaginary line to indicate the area of the screen A2 and not an actually projected line.

### 3-3. One-Screen Display

In the case where the screen configuration of one-screen display is set and an image signal representing an image with the aspect thereof matching the screen is inputted, the control unit 15 sets the screen itself as the drawing area of the external image.

In the case where the screen configuration of one-screen display is set and an image signal representing an image with a different aspect from the screen is inputted, as shown in FIG. 4A, the control unit 15 sets the drawing area A22s of the external, image A22 in such a way that two sides of the drawing area A22s of the external image A22 and two sides of the screen overlap with each other, that the external image A22 does not stick out of the screen, and that the centroid of the screen drawing area A22s of the external image A22 and the centroid of the screen coincide with each other, as shown in FIG. 4B.

### 3-4. Two-Screen Equal-Division Display

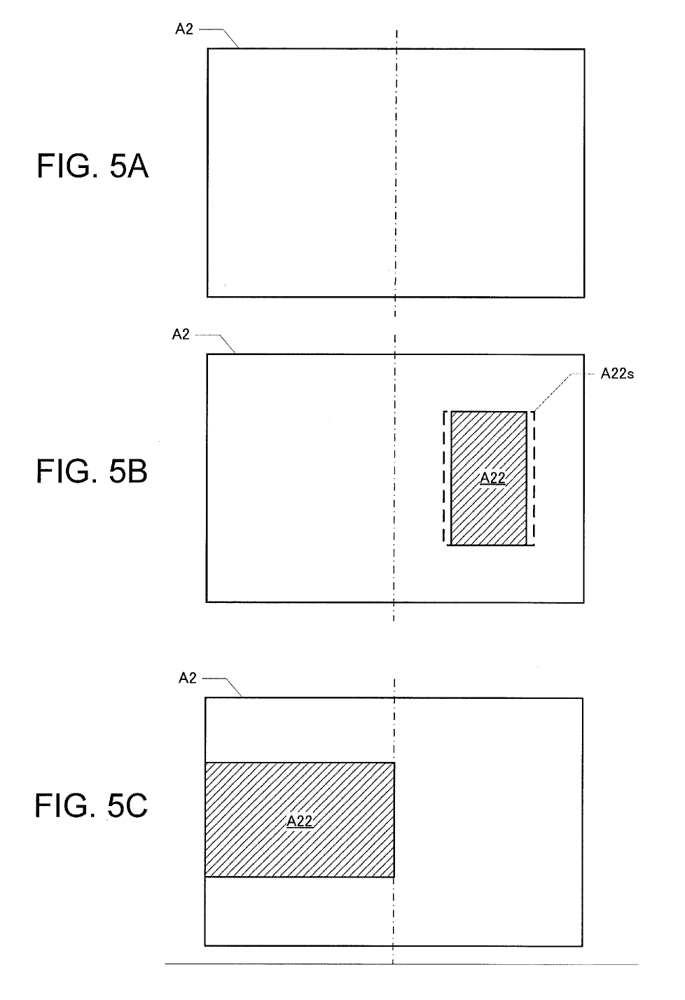

In the case where the screen configuration of two-screen equal-division display is set, the control unit 15 divides the screen into two equal parts on the left and right, as indicated by the one-dot chain line in FIG. 5A. The control unit 15 then allocates one of the left and right areas as a maximum area where a first external image based on an image signal inputted from a first external device is to be drawn, and allocates the other of the left and right areas as a maximum area where a second external image based on an image signal inputted from a second external device is to be drawn.

In the case where an image signal representing a vertically long image is inputted, the control unit 15 sets the drawing area of the external image, using a template A22s that defines the area (template area) indicated by the dashed line in FIG. 5B. The template A22s defines a vertically long area arranged in the center of one of the left and right maximum areas where an external image is to be drawn, as the drawing area within which the external image should fall. If the template A22s and the external image have the same aspect, the drawing area of the external image with respect to the screen A2 is the area of the template A22s itself. If the template A22s and the external image A22 have different aspects, as shown in FIG. 5B, an area that falls within the template A22s, has the same aspect as the external image A22, and has two opposite sides overlapping with two opposite sides of the template A22s, is set as the drawing area of the external image A22.

In the case where an image signal representing a horizontally long image is inputted, the control unit 15 sets the drawing area of the external image A22 in such a way that two opposite sides of the external image A22 overlap with two opposite sides of the maximum area where an external image is to be drawn, that the external image A22 does not stick out from the maximum area where an external image is to be drawn, and that the centroid of the maximum area where an external image is to be drawn and the centroid of the external image A22 coincide with each other, as shown in FIG. 5C.

### 4. Movement Instruction

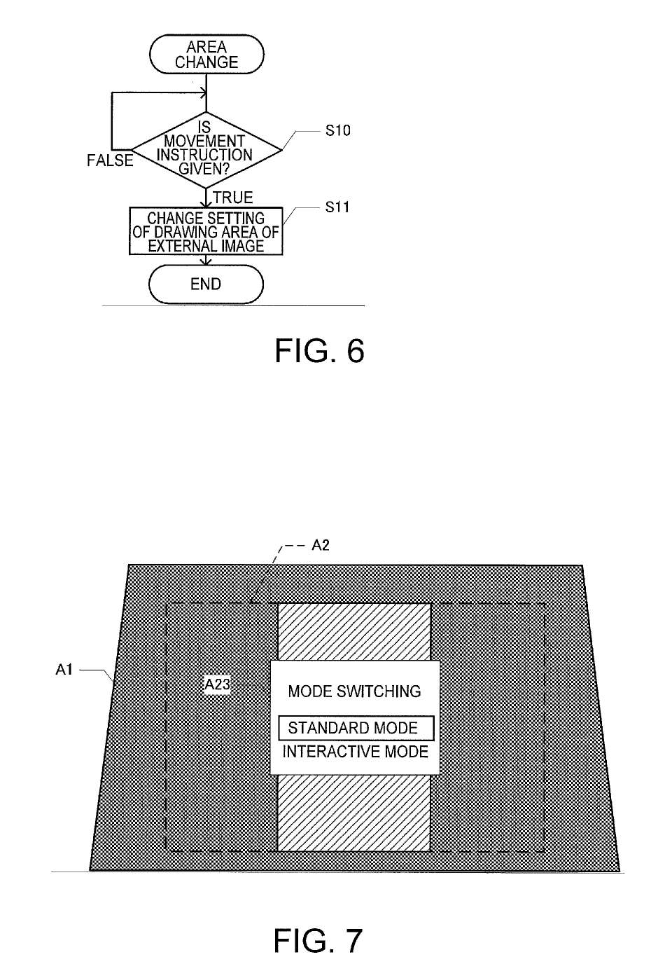

As shown in FIG. 6, the projector 1 changes the drawing area of the external image in response to a movement instruction.

First, the control unit 15 determines whether a movement instruction is detected or not (S10). Specifically, the control unit 15 detects a connection operation of an external device to the USB terminal of the image signal input unit 14, an operation on the OSD menu, an operation of the electronic pen 23, an operation to a predetermined area on the projection surface, or the like, as a movement instruction. For example, if the menu key 181 or the like of the operation unit 18 is operated, the control unit 15 generates window image data in which an OSD menu A23 for selecting a mode is drawn at the forefront of the screen A2 as shown in FIG. 7, and waits for selection of an item. In the OSD menu A23, a “standard mode” referring to the first mode, and an “interactive mode” referring to the second mode are arranged as selection items. In the case where the “interactive mode” is selected using the selection key 182 and the decision key 183 of the operation unit 18 in the first mode, a shift from the first mode to the second mode may be made and the selection operation may be detected as a movement instruction. That is, the instruction itself to shift from the first mode to the second mode may be detected as a movement instruction. In this case, the operation unit 18 functions as a movement instruction detection unit. Thus, as the shift to the second mode is made, in which an operation input image corresponding to an operation can be projected, the external image automatically moves in such a way that a note or the like can be recorded more easily on the area outside the external image. Consequently, an operation of requesting the user to move the external image can be eliminated.

In the second mode, the control unit 15 may detect an operation of removing the electronic pen 23 from a pen holder 234 as a movement instruction. In this case, when the electronic pen 23 is removed from the pen holder 234, the pen holder 234 detects this and notifies the control unit 15 of this matter. That is, the pen holder 234 functions as a movement instruction detection unit. If, after the electronic pen 23 is removed from the pen holder 234, the user performs an OFF-operation of the power switch 233 without returning the electronic pen 23 to the pen holder 234 and then performs an ON-operation again, this ON-operation may be detected as a movement instruction. In this case, there is a need for a measure for the electronic pen 23 to notify the control unit 15 of the ON-operation and OFF-operation of the power switch 233. For example, the light emitting unit 232 of the electronic pen 23 may be used as this measure. In this case, the electronic pen 23 and the receiving unit 21 function as a movement instruction detection unit.

Also, in the second mode, the control unit 15 may detect an operation to a predetermined area on the projection surface as a movement instruction. In this case, the electronic pen 23 and the receiving unit 21 function as a movement instruction detection unit. In the first mode, too, in order to detect an operation to a predetermined area on the projection surface as a movement instruction, the electronic pen 23, the receiving unit 21 and the position detection unit 22 need to be activated. In the case of detecting an operation to a limited narrow area on the projection surface as a movement instruction, it is preferable that the control unit 15 draws an icon in the area so that the user can recognize the area.

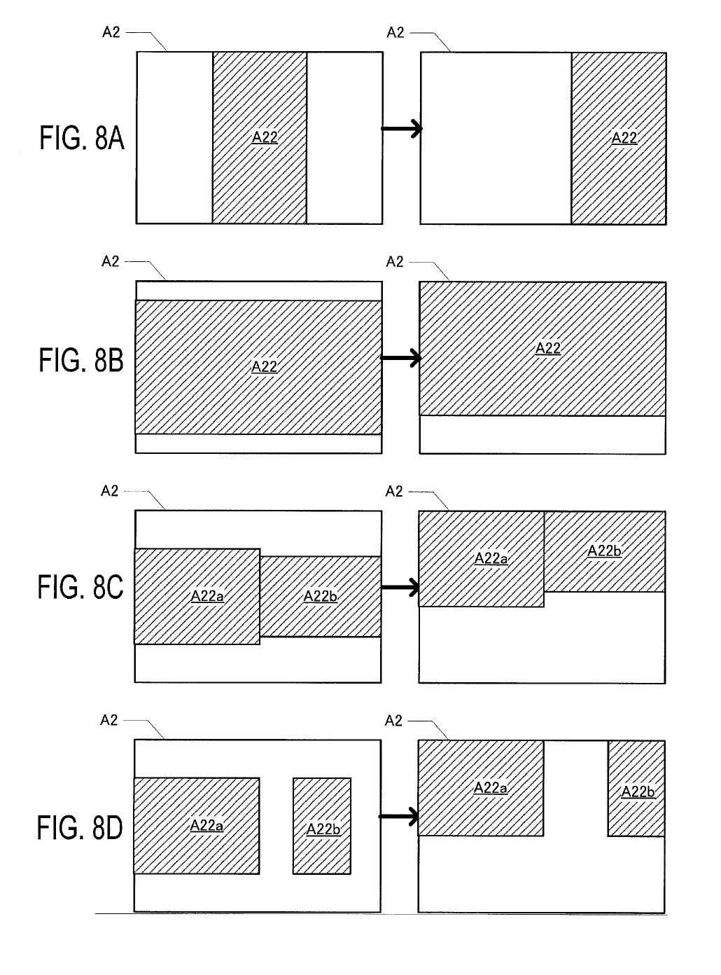

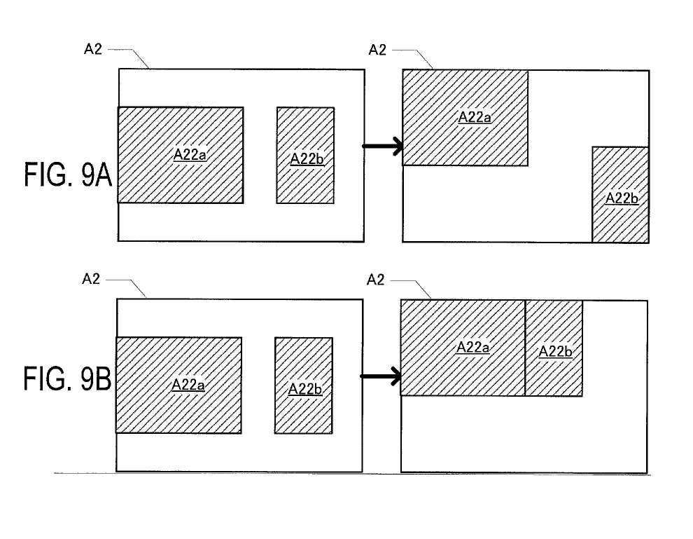

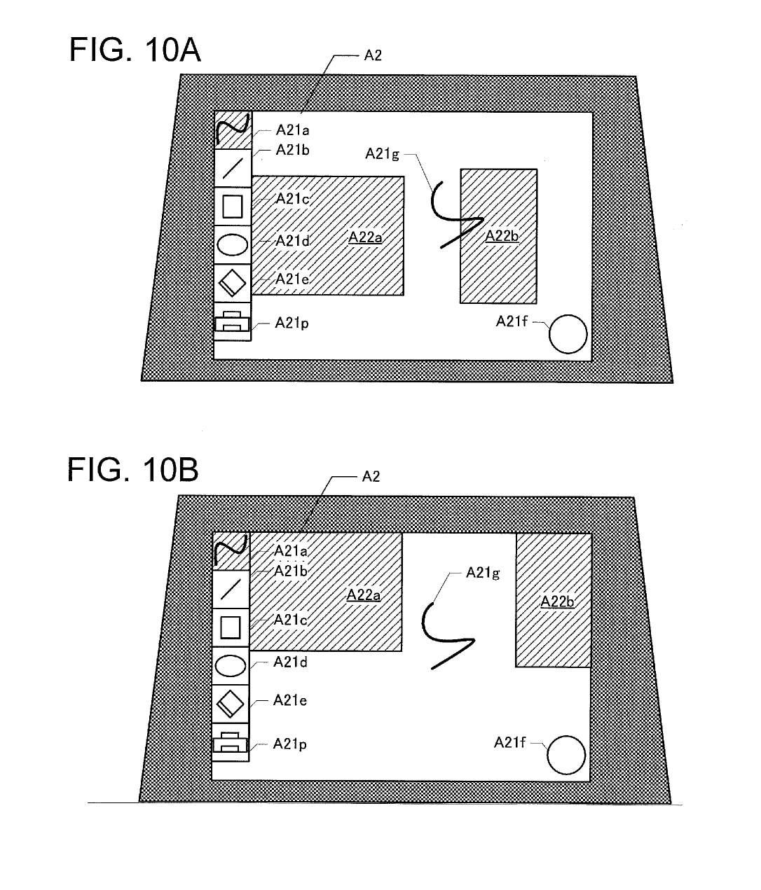

If it is determined that a movement instruction is detected, the control unit 15 changes the setting of the drawing area of the external image (S11). Specifically, as a movement instruction is detected, the control unit 15 moves the drawing area of the external image A22 in such a direction that the external image approaches a side of the screen A2, as shown in FIGS. 8A to 8D and FIGS. 9A and 9B. If a movement instruction is detected in the second mode, for example, the projection area A1 changes from what is shown in FIG. 10A to what is shown in FIG. 10B.

In the case where the screen configuration of one-screen display is set, the drawing area of the external image A22 is changed in such a way that one of the two sides of the external image A22 that are not in contact with any side of the screen A2 comes into contact with a side of the screen A2, as shown in FIGS. 8A and 8B. Consequently, three sides of the external image A22 overlap with sides of the screen A2, and the two areas outside the external image A22 are gathered into one area. Therefore, the one gathered area outside the external image A22 is broad.

Meanwhile, in the case where the screen configuration of two-screen equal-division display is set, for example, the drawing areas of two external images A22a, A22b are changed in such away that both of the two external images A22a, A22b move vertically upward, with one apex of the external image A22a and one apex of the external image A22b coinciding with neighboring apexes of the screen A2, as shown in FIG. 8C. Alternatively, the drawing areas of two external images A22a, A22b are changed in such a way that the two external images A22a, A22b move horizontally in the opposite directions to each other and contact two opposite sides of the screen A2, as shown in FIG. 8D. Also, the drawing areas of two external images A22a, A22b are changed in such a way that one apex of the external image A22a and one apex of the external image A22b coincide with opposite apexes of the screen A2, as shown in FIG. 9A. As the drawing areas are changed as shown in FIG. 8D and FIG. 9A, the area outside the external images A22a, A22b becomes broader in the center of the screen A2.

In the case where the screen configuration of two-screen equal-division display is set and two external images A22a, A22b are spaced apart from each other, one of the two external images A22a, A22b may be moved in a direction of approaching two sides of the screen A2 while the other external image may be moved to share a side with the one external image, as shown in FIG. 9B.

In the case where the screen configuration of two-screen equal-division display is set, if the drawing areas of the external images are moved into contact with sides of the screen A2, the two external images move different distances in most cases.

### 5. Drawing Processing in Second Mode

In the second mode, the control unit 15 draws the area outside the screen A2 in the projection area A1, in black, and draws the back area of the external image A22 in the screen A2, in white, as shown in FIG. 1B. Therefore, when a shift from the first mode to the second mode is made, the color of the back area of the external image A22 changes from black to white in the screen A2.

In the second mode, the operation input object A21g corresponding to an operation on the screen is arranged along with the external image A22 at the front of the white back area in the screen A2. The operation input object A21g is an image that is uniquely generated by the control unit 15 of the projector 1. Therefore, the response of the operation input object A21g corresponding to an operation on the screen is fast. The resolution of an operation input image A21 in which the operation input object A21g is drawn is the same as the resolution of the screen A2. In the operation input image A21, various icons A21a, A21b, A21c, A21d, A21e, A21f, A21p, and the object A21g corresponding to an operation using the electronic pen 23 are drawn by the control unit 15.

The icons A21a, A21b, A21c, A21d, A21e indicate areas for allowing the user to select which graphic pattern reflects an operation using the electronic pen 23 on the projection surface, onto the operation input object A21g. That is, when an operation position signal indicating the area where the icons A21a, A21b, A21c, A21d, A21e are drawn is inputted from the position detection unit 22, the control unit 15 prepares the drawing processing corresponding to each area. For example, when the tip of the electronic pen 23 contacts the area where the icon A21a is projected, the control unit 15 draws the subsequent contact trajectory of the tip of the electronic pen 23 to the projection surface, as the object A21g at the forefront of the screen A2. When the tip of the electronic pen 23 contacts the area where the icon A21b is projected, the control unit 15 changes the thickness of the line drawn in the operation input image A21. When the tip of the electronic pen 23 contacts the area where the icon A21c is projected, the control unit 15 draws a rectangular object in which the start point and end point of the subsequent contact trajectory of the tip of the electronic pen 23 to the projection surface define two diagonal ends, at the forefront of the screen A2. When the tip of the electronic pen 23 contacts the area where the icon A21d is projected, the control unit 15 draws an ellipse inscribed in a rectangle in which the start point and end point of the subsequent contact trajectory of the tip of the electronic pen 23 to the projection surface define two diagonal ends, at the forefront of the screen A2. When the tip of the electronic pen 23 contacts the area where the icon A21e is projected, the control unit 15 erases the object A21g such as a curve corresponding to the previous operation on the screen using the electronic pen 23, from the subsequent contact trajectory of the tip of the electronic pen 23 to the projection surface. During the preparation or execution of the drawing processing corresponding to the icons A21a, A21b, A21c, A21d, A21e, the control unit 15 performs drawing to highlight the corresponding icons A21a, A21b, A21c, A21d, A21e. Then, when the tip of the electronic pen 23 contacts the area where the mode switching icon A21f is projected in the second mode, the control unit 15 shifts to the first mode.

According to the above example, the user can move an external image toward an end from the center of the screen and gather the areas outside the external image within the screen. Therefore, a note or the like can be recorded more easily in the area outside the external image. Also, since the external image is moved with a shift from the first mode to the second mode, an operation of requesting the user to do the same can be eliminated. Moreover, since an operation to a predetermined area on the screen is detected as a movement instruction, the user can move the external image toward an end from the center of the screen without leaving the screen.

### 6. Other Embodiments

The technical field of the invention is not limited to the above example. Various changes can be added without departing from the scope of the invention.

For example, when changing the drawing area of an external image, a certain trigger may be provided during the period when the projector operates in the second mode, instead of changing the drawing area of the external image in the timing of shifting from the first mode to the second mode. For example, instead of changing the drawing area of the external image in the timing when a shift from the first mode to the second mode is made by an operation of the OSD menu or by the connection of an external device to the USB terminal, the drawing area of the external image may be changed in the timing when the power switch of the electronic pen is operated in the second mode, the electronic pen is removed from the pen holder in the second mode, the first operation to an arbitrary area where an operation on the screen can be detected is carried out in the second mode, or an operation to a predetermined area indicated by an icon is carried out in the second mode.

Also, when changing the drawing area of an external image, the external image may be moved until a side of the external image that is not in contact with any side of the screen comes into contact with a side of the screen, or the movement distance of the external image may stop before the point where a side of the external image that is not in contact with any side of the screen comes into contact with a side of the screen.

Moreover, as a measure for detecting an operation on the screen, for example, a laser curtain may be used or light of other wavelengths than infrared wavelength may be used. Instead of using a transmitting unit having the function of transmitting an operation signal such as an electronic pen, infrared-wavelength light that is cast from a laser curtain and reflected by a finger may be detected, thus detecting an operation on the screen. The area where an operation to draw an operation input object is detected may be the entire screen or may be limited to a part of the screen. For example, an operation to draw an operation input unit may be detected only with respect to the back area of the external image in the screen.

Also, to project an image, for example, a single liquid crystal panel may be used to modulate light, or a reflection-type liquid crystal panel may be used to modulate light. A DMD (digital mirror device) may be used to modulate light. Meanwhile, to perform enlarged projection of a projection image, for example, a convex mirror may be used, or a mirror may not be used. Also, the invention may be applied, for example, to a display device such as a touch panel display.

What is claimed is:

1. A bidirectional display method comprising:
receiving an image signal inputted from an external device;
displaying an image on a screen on the basis of a display signal;
detecting an operation on the screen;
outputting the display signal for displaying the image formed by combining an external image based on the image signal and an operation input object corresponding to the operation on the screen;
detecting a predetermined operation as a movement instruction; and
outputting the display signal for displaying the external image moved in a direction toward a side of the screen, when the movement instruction is detected.

2. The bidirectional display method according to claim 1, wherein
in the detecting of the movement instruction, an operation to a predetermined area in the screen is detected as the movement instruction.

3. The bidirectional display method according to claim 1, wherein
when the movement instruction is detected, each external image of a plurality of the external images is moved in a different direction from the others.

4. The bidirectional display method according to claim 1, wherein
when the movement instruction is detected, each external image of a plurality of the external images is moved by a different distance from the others.

5. The bidirectional display method according to claim 1, wherein
when the movement instruction is detected, a plurality of the external images is moved in such a way as to contact each other.

6. A bidirectional display device comprising:
an image signal input unit which receives an image signal inputted from an external device;
a display unit which displays an image on a screen on the basis of a display signal;
an operation detection unit which detects an operation on the screen;
a movement instruction detection unit which detects a predetermined operation as a movement instruction; and
a drawing unit which outputs the display signal for displaying the image formed by combining an external image based on the image signal and an operation input object corresponding to the operation on the screen, and outputs the display signal for displaying the external image moved in a direction toward a side of the screen when the movement instruction is detected.
